(19) United States
(12) Patent Application Publication
(10) Pub. No.: US 2014/0020806 A1
(43) Pub. Date: Jan. 23, 2014

(54) PNEUMATIC TIRE

(71) Applicants: Ludovic Greverie, Ota-shi (JP); Alain Parfondry, Clermont-Ferrand (FR); Antonio Delfino, Clermont-Ferrand (FR); Damien Fombelle, Clermont-Ferrand (FR)

(72) Inventors: Ludovic Greverie, Ota-shi (JP); Alain Parfondry, Clermont-Ferrand (FR); Antonio Delfino, Clermont-Ferrand (FR); Damien Fombelle, Clermont-Ferrand (FR)

(73) Assignees: Michelin Recherche Et Technique S.A., Granges-Paccot (CH); Compagnie Generale Des Etablissments Michelin, Clemont-Ferrand (FR)

(21) Appl. No.: 13/976,489

(22) PCT Filed: Dec. 27, 2011
(86) PCT No.: PCT/JP2011/080334

§ 371 Date: Oct. 1, 2013

(30) Foreign Application Priority Data
Dec. 28, 2010 (JP) PCT/JP2010/073754

(51) Int. Cl. B60C 5/00

(52) U.S. Cl. CPC B60C 19/002
USPC 152/450

(57) ABSTRACT

A pneumatic tire provided with a noise damper in the tire cavity, which can maintain high-speed durability and productivity while also reducing cavity resonance, comprising a tread having a width TW in contact with the ground during travel, in which a noise damper made of a sound-absorbing material is attached to the tire internal surface in order to reduce cavity resonance, wherein the noise damper is at least one continuous ribbon made of a sound-absorbing material and having a width W and a thickness E, which is fixed over an attachment width Wc to the tire internal surface over a range of at least 30% of the inside of the tread in the radial direction, the start end and terminal end which are the two ends of the continuous ribbon are disposed in such a way as to be offset from each other in the axial direction, and the continuous ribbon forms, together with the tire internal surface, a continuous groove having a groove width D which is at least equal to 10% of the width W of the continuous ribbon.

### BACKGROUND

1. Technical Field

The present invention relates to a pneumatic tire, and specifically the invention relates to a pneumatic tire provided with a noise damper for suppressing cavity resonance produced in a tire cavity.

2. Description of Related Art

Resonant vibration (cavity resonance) in a tire cavity is generated by the vibration of air enclosed in the tire cavity. The air in the tire cavity is generally excited by deformation of the tire tread part and sidewall part as the tire travels, and air enclosed in the annular cavity acts as an air column when this air is excited.

Sound waves which are excited in the tire cavity are transmitted inside the vehicle compartment as a solid-borne sound which spreads through the wheels, suspension and motor vehicle body, and is felt by vehicle passengers as disagreeable low-frequency noise.

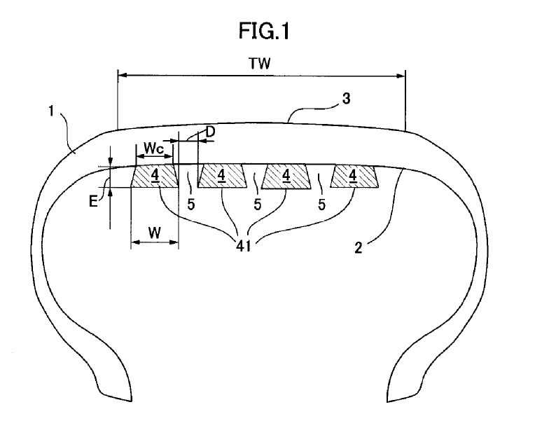

Introducing a noise damper into the tire cavity is known as an effective means for reducing the cavity resonance, and FIG. 1 of Patent Document 1 shows technology in which a sponge noise damper having a trapezoidal shape is fixed to an internal surface of a tire in such a way as to extend in the direction of rotation of the tire, whereby cavity resonance is reduced.

Furthermore, FIG. 1 of Patent Document 2 shows technology in which a sponge noise damper comprising two essentially trapezoidal shapes so as to be provided with a trough part in the middle is fixed to an internal surface of a tire in such a way as to extend in the direction of rotation of the tire, whereby cavity resonance is reduced.

In addition, FIG. 1 of Patent Document 3 shows technology in which a plurality of independent ribbon-shaped noise dampers are fixed to an internal surface of a tire in such a way as to extend in the direction of rotation of the tire, which achieves both a reduction in cavity resonance and high-speed durability.

Patent Document 1: WO2003/103989

Patent Document 2: JP2007-161069A

Patent Document 3: JP2005-262920A

### SUMMARY

However, the material which is generally used for the noise damper has low thermal conductivity, so there is a problem with the technology described in Patent Documents 1 and 2 in that the high-speed durability of the tire is reduced when the noise damper covers a wide range of the order of 40% of the tire internal surface in order to reduce cavity resonance.

Furthermore, there is a problem with the technology described in Patent Document 3 in that the process to fit the noise dampers to the tire internal surface is complex because multiple noise dampers have to be introduced, so the productivity of this kind of tire is reduced.

In addition, in recent years there has been a demand for pneumatic tires which can further reduce cavity resonance in order to further reduce disagreeable low-frequency noise which is transmitted to vehicle passengers.

The present invention has therefore been devised in order to resolve the abovementioned problems of the prior art, and the aim thereof lies in providing a pneumatic tire provided with a noise damper in the tire cavity, which can maintain high-speed durability and productivity while also reducing cavity resonance.

In order to achieve the abovementioned aim, the present invention provides a pneumatic tire comprising a tread, a cavity enclosed by a tire internal surface, and a noise damper for reducing cavity resonance in said cavity, said pneumatic tire being characterized in that: the noise damper is at least one continuous ribbon which is formed by a predetermined sound-absorbing material and has a width W and thickness E, and a bottom surface affixed to the tire internal surface over a width Wc, which is fixed to the tire internal surface in such a way as to cover a range of at least 30% of the inside of the tire in the radial direction corresponding to the tread on the tire internal surface; the at least one continuous ribbon is disposed in such a way as to run at least once around the tire internal surface about the axis of rotation thereof, and in such a way that the start end and terminal end of the at least one continuous ribbon arc offset from each other in the direction of the axis of rotation of the tire, and as a result a continuous groove having a groove width D which is at least 10% of the width W of the at least one continuous ribbon is formed by the adjacent portions of the at least one continuous ribbon and the tire internal surface; and the width Wc of the bottom surface of the continuous ribbon is smaller than the width W of the continuous ribbon.

According to the present invention having the abovementioned construction, the start end and terminal end of the at least one continuous ribbon are disposed in such a way as to be offset from each other in the axial direction, so a continuous ribbon such as this is disposed in such a way as to extend along a predetermined angle with respect to the circumferential direction of the tire, and it is possible to impede vibration of air which is excited in the tire cavity and propagates in the circumferential direction of the tire, and as a result cavity resonance is improved.

In addition, according to the present invention, a continuous groove is formed by the spaces between adjacent continuous ribbons and the tire internal surface as a result of the continuous ribbon, so vibration of air in the tire cavity is conducted to the continuous groove, and this continuous groove is formed by a continuous ribbon whereof the start end and terminal end are offset in the axial direction and which runs at least once around the tire internal surface about the axis of rotation thereof, so the direction in which air vibration is propagated (the circumferential direction of the tire) is different from the direction in which the continuous ribbon runs, and as a result propagation of air vibration in the tire cavity is impeded by means of the continuous groove and cavity resonance is improved.

Here, the energy of the air vibration conducted into the continuous groove is divided into a component which permeates into the continuous ribbon and a component which is reflected by the surface of the continuous groove of the continuous ribbon. The energy component which permeates into the continuous ribbon is attenuated by the sound-absorbing effect of the continuous ribbon constituting the noise damper, and the component which is reflected by the surface of the continuous groove of the continuous ribbon is not only attenuated by reflection thereof, the energy thereof also reaches other sections of the continuous ribbon whereby the abovementioned permeation/reflection phenomena are repeated, so cavity resonance can be more effectively improved.

In addition, according to the present invention, the continuous groove is formed by means of the continuous ribbon and the tire internal surface, and the groove width is at least 10% of the width W of the continuous ribbon, so the area over which the tire internal surface comes into direct contact with air in the tire cavity by way of the continuous groove can be made a sufficient area to radiate heat. This means that the heat generated mainly in the tread as the tire travels can be reliably released into the tire cavity from the tire internal surface even though the noise damper is provided, and as a result it is possible to maintain high-speed durability.

In addition, according to the present invention, the width Wc of the bottom surface of the continuous ribbon affixed to the tire internal surface is smaller than the width W of the continuous ribbon, so the area over which the tire internal surface comes into direct contact with air in the tire cavity by way of the continuous groove can be increased. This means that the heat generated mainly in the tread as the tire travels can be reliably released into the tire cavity from the tire internal surface even though the noise damper is provided, and as a result it is possible to maintain high-speed durability.

In addition, with the pneumatic tire according to the present invention constructed in the above manner, if the continuous ribbon is fixed in the tire cavity, for example, the start end thereof is fixed to the tire internal surface, after which the continuous ribbon should continue to be fixed up to the terminal end thereof while the tire is rotated about the axis of rotation thereof and the continuous ribbon or the tire itself is moved in the axial direction. In this way, it is possible to attach the continuous ribbon with relative ease, and the productivity of a tire provided with a noise damper can be maintained.

According to the present invention, the ratio of the width W of the at least one continuous ribbon to the width Wc of the bottom surface (W/Wc) is preferably at least equal to 1.2.

According to the present invention constructed in this way, it is possible to ensure high-speed durability and to maintain productivity while a reduction in cavity resonance can be envisaged. That is to say, if the ratio of the width W of the continuous ribbon to the width Wc of the bottom surface (W/Wc) is less than 1.2, the area over which the tire internal surface comes into direct contact with air in the tire cavity by way of the continuous groove is reduced, so there is a reduction in high-speed durability. Accordingly, if the ratio of the width W of the continuous ribbon to the width Wc of the bottom surface (W/Wc) is at least equal to 1.2, it is possible to ensure high-speed durability and to maintain productivity with greater reliability while a reduction in cavity resonance can be envisaged.

According to the present invention, preferably the dread has a width TW, and the width W of the at least one continuous ribbon is between 5% and 25% of the width TW of the tread.

According to the present invention constructed in this way, it is possible to ensure high-speed durability and to maintain productivity while a reduction in cavity resonance can be envisaged. That is to say, if the width W of the continuous ribbon is less than 5% of the tread width TW, the width W of the continuous ribbon is excessively small, and it is necessary to increase the number of turns of the continuous ribbon in order to effectively reduce cavity resonance, and productivity is reduced. On the other hand, if the width W of the continuous ribbon is more than 25% of the tread width TW, the proportion of the tire internal surface occupied by the continuous ribbon increases, and as a result the proportion of the tire internal surface which comes into contact with air in the tire cavity is reduced whereby the high-speed durability is reduced. Accordingly, if the width W of the continuous ribbon is set between 5% and 25% of the tread width TW, it is possible to ensure high-speed durability and to maintain productivity while a reduction in cavity resonance can be envisaged.

According to the present invention, the at least one continuous ribbon is preferably disposed in such a way as to run at least twice around the tire internal surface.

According to the present invention constructed in this way, the continuous groove which is formed by the continuous ribbon runs at least once around the tire internal surface, so it is possible to achieve effective attenuation of air vibration, and as a result high-speed durability can be more reliably ensured while a reduction in cavity resonance can be envisaged.

According to the present invention, preferably, there are two of the abovementioned at least one continuous ribbon, and the continuous groove is formed for each of the two continuous ribbons by the continuous ribbons and the tire internal surface.

According to the present invention constructed in this way, the degree of freedom in positioning the continuous ribbons can be increased, for instance the positions at which the continuous ribbons are fixed to the tire internal surface can be optimized in order to suppress cavity resonance, so high-speed durability can be more effectively ensured while a reduction in cavity resonance can be envisaged.

According to the present invention, preferably, there are two of the abovementioned at least one continuous ribbon, namely a first continuous ribbon extending in a predetermined angular direction with respect to the circumferential direction of the tire about the axis of rotation of the tire, and a second continuous ribbon extending in a direction which is symmetrical, with respect to the circumferential direction of the tire, to the predetermined angular direction along which the first continuous ribbon runs.

According to the present invention constructed in this way, the degree of freedom in positioning the continuous ribbons can be increased, for instance the positions at which the continuous ribbons are fixed to the tire internal surface can be optimized in order to suppress cavity resonance, so high-speed durability can be more effectively ensured while a reduction in cavity resonance can be envisaged.

According to the present invention, the predetermined sound-absorbing material of the at least one continuous ribbon is preferably selected from the group consisting of sponge, a foamed rubber composition, glass wool, rock wool, and cellulose fiber. These materials have excellent anti-vibration properties and sound suppression properties, so it is possible to envisage a reduction in cavity resonance.

According to the present invention, the thickness E of the at least one continuous ribbon is preferably between 50% and 200% of the width W of the at least one continuous ribbon.

According to the present invention constructed in this way, it is possible to envisage a more effective reduction in cavity resonance. That is to say, if the thickness E of the continuous ribbon is less than 50% of the width W of the continuous ribbon, the thickness E of the continuous ribbon does not have a sufficient height to impede propagation of sound waves from air vibration in the tire cavity, so the degree of reduction in cavity resonance is reduced. On the other hand, if the thickness E of the continuous ribbon is greater than 200% of the width W of the continuous ribbon, the sound-suppression effect afforded by the continuous ribbon plateaus, and therefore this adversely affects the cost and weight of the tire. Accordingly, if the thickness E of the continuous ribbon is set between 50% and 200% of the width W of the continuous ribbon it is possible to reduce cavity resonance more effectively.

According to the present invention, the groove width D of the continuous groove is preferably formed in such a way as to vary in a range between 10% and 250% of the width W of the at least one continuous ribbon in the direction in which the at least one continuous ribbon runs.

According to the present invention constructed in this way sound waves from the vibration of air introduced into the continuous groove permeate into/are reflected by the continuous ribbon in an irregular fashion, so it is possible to ensure high-speed durability and to maintain productivity more effectively while a reduction in cavity resonance can be envisaged.

The pneumatic tire according to the present invention makes it possible to maintain high-speed durability and productivity while reducing cavity resonance.

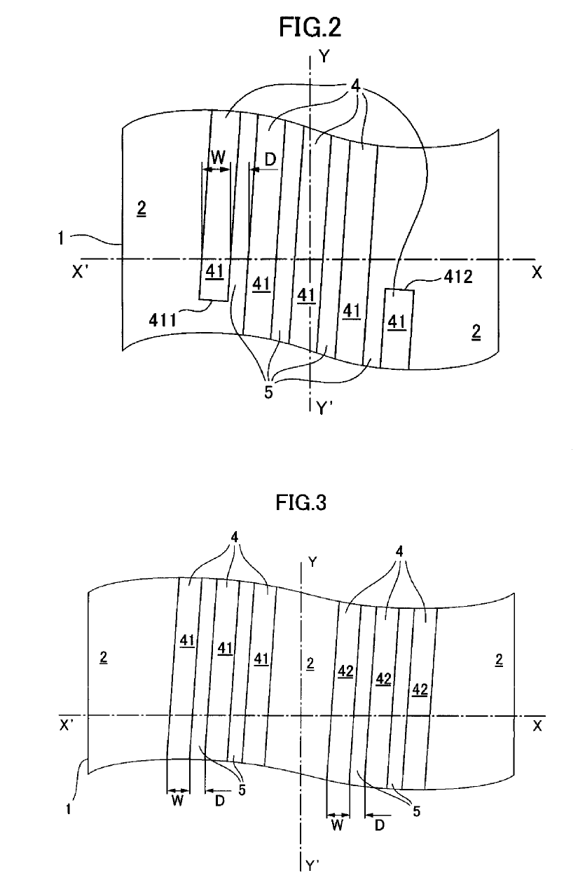

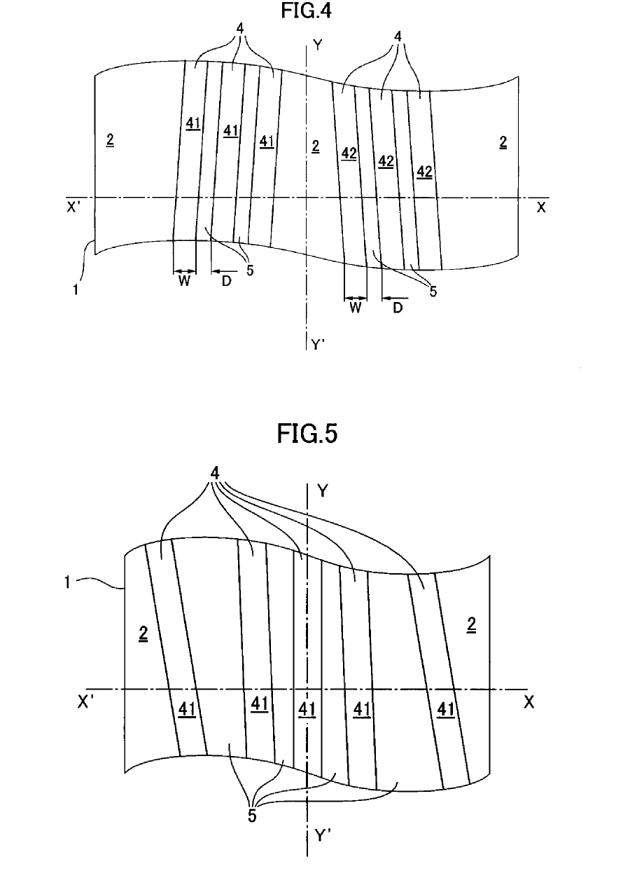

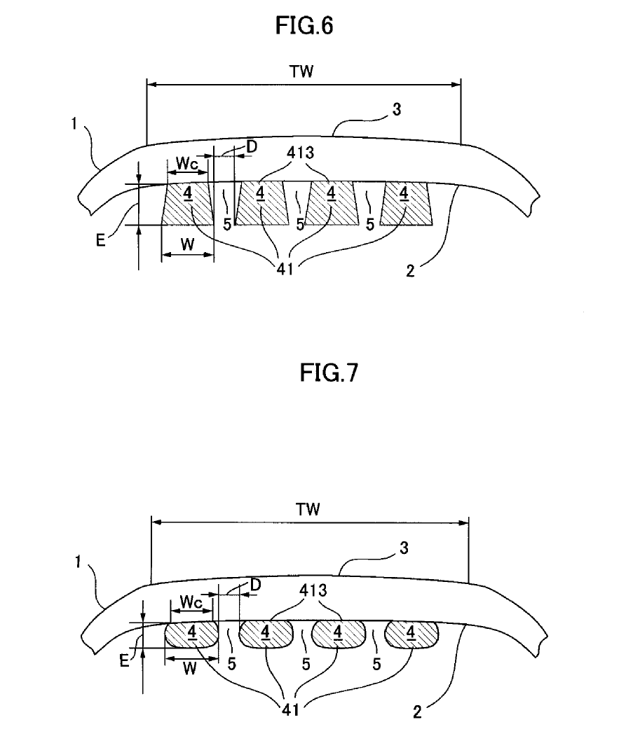

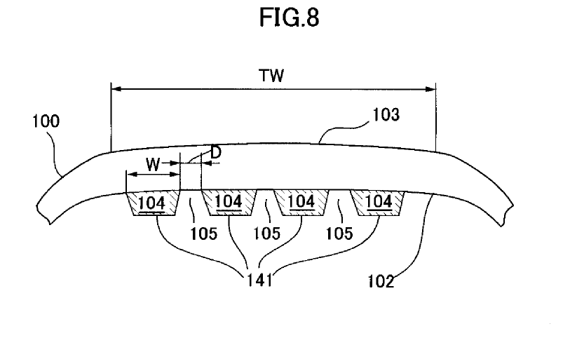

### BRIEF DESCRIPTION OF DRAWINGS

[FIG. 1] is a schematic view in cross section in the radial direction of a pneumatic tire provided with a noise damper according to a first mode of embodiment of the present invention.

[FIG. 2] is a schematic view of the internal surface of a pneumatic tire provided with a noise damper according to a first mode of embodiment of the present invention.

[FIG. 3] is a schematic view of the internal surface of a pneumatic tire provided with a noise damper according to a second mode of embodiment of the present invention.

[FIG. 4] is a schematic view of the internal surface of a pneumatic tire provided with a noise damper according to a third mode of embodiment of the present invention.

[FIG. 5] is a schematic view of the internal surface of a pneumatic tire provided with a noise damper according to a fourth mode of embodiment of the present invention.

[FIG. 6] is a schematic view in cross section in the radial direction of a pneumatic tire provided with a noise damper according to a fifth mode of embodiment of the present invention.

[FIG. 7] is a schematic view in cross section in the radial direction of a pneumatic tire provided with a noise damper according to a sixth mode of embodiment of the present invention.

[FIG. 8] is a schematic view in cross section in the radial direction of a pneumatic tire provided with a noise damper according to the prior art.

### DETAILED DESCRIPTION OF SPECIFIC EMBODIMENTS

Preferred modes of embodiment of the present invention will be described below with reference to the figures.

A pneumatic tire according to a first mode of embodiment of the present invention will be described first of all with reference to FIGS. 1 and 2.

FIG. 1 is a schematic view in cross section in the radial direction of a pneumatic tire provided with a noise damper according to a first mode of embodiment of the present invention, and FIG. 2 is a schematic view of the internal surface of a pneumatic tire provided with a noise damper according to a first mode of embodiment of the present invention. In FIG. 2 the circumferential direction of the tire is denoted by YY′, and the axial direction of the tire is denoted by XX′.

First of all, as shown in FIG. 1, the symbol 1 denotes a pneumatic tire 1 which is provided with a noise damper 4 according to a first mode of embodiment of the present invention. The noise damper 4 serves to reduce cavity resonance, and as shown in FIGS. 1 and 2, it consists of a continuous ribbon 41 having a continuous width W and thickness E, and is fitted to the internal surface 2 of the pneumatic tire by a bottom surface having a width Wc which is affixed to the tire internal surface. Here, “the tire internal surface” (tire internal surface 2) refers to the surface of the tire facing the cavity, and in the normal state of usage of the tire (a state in which the tire is attached to a wheel) this surface cannot be seen from the outside.

The continuous ribbon 41 is formed by a single continuous ribbon 41 which is continuously attached to the tire internal surface 2 running four times around said internal surface, in such a way as to be angled with respect to the circumferential direction of the tire, in other words in such a way as to extend in an oblique direction with respect to the circumferential direction of the tire. Continuous grooves 5 having a groove width D extending three times around the tire are formed on the internal surface 2 thereof by means of adjacent continuous ribbons 41 and the tire internal surface 2, as a result of a single continuous ribbon 41 being continuously attached four times around the tire internal surface. The continuous grooves 5 formed in this way also extend in such a way as to be angled with respect to the circumferential direction of the tire as shown in FIG. 2. That is to say, in this mode of embodiment, the continuous ribbon 41 is attached in such a way as to extend at a predetermined angle with respect to the circumferential direction of the tire, and the continuous grooves 5 are formed by adjacent continuous ribbons 41 and the tire internal surface 2.

Here, the width W of the continuous ribbon 41 is the maximum width projected onto the tire internal surface 2, the thickness E is the maximum thickness in the radial direction of the tire, the width Wc of the bottom surface of the continuous ribbon 41 which is affixed to the tire internal surface is the width of a portion parallel to the tire internal surface 2 of the attached continuous ribbon 41 affixed to the tire internal surface 2 projected onto the tire internal surface 2, and the width D of the continuous groove formed by the continuous ribbon 41 is the maximum gap between adjacent continuous ribbons 41 projected onto the tire internal surface 2.

As shown in FIG. 1, the tire 1 has a tread surface 3 having a width TW which comes into contact with the road surface during travel. It should be noted that the tire size in this example is 225/55R16.

The width W of the continuous ribbon 41 is formed in such a way as to be between 5% and 25% of the width TW of the tread 3. In this mode of embodiment the width TW of the tread 3 is 168 mm and the width W of the continuous ribbon 41 is 24 mm.

The thickness E of the continuous ribbon 41 is formed in such a way as to be between 50% and 200% of the width W of the continuous ribbon 41. In this mode of embodiment the thickness E of the continuous ribbon 41 is 15 mm.

The width Wc of the bottom surface of the continuous ribbon 41 which is affixed to the tire internal surface is formed in such a way as to be smaller than the width W of the continuous ribbon 41. Furthermore, the ratio of the width W of the continuous ribbon 41 to the width Wc of the bottom surface which is affixed to the tire internal surface (Wc/W) is formed in such a way as to be at least equal to 1.2. In this mode of embodiment, the width Wc of the bottom surface of the continuous ribbon 41 which is affixed to the tire internal surface is 18 mm, and the ratio of the width W of the continuous ribbon 41 to the width Wc of the bottom surface which is affixed to the tire internal surface (Wc/W) is 1.3. It should be noted that the ratio of the width W of the continuous ribbon to the width Wc (W/Wc) is preferably no greater than 3.0 in order to fix the noise damper more securely during travel of the tire.

The continuous ribbon 41 is made of a sound-absorbing material which has excellent anti-vibration properties and sound absorption properties. The continuous ribbon 41 is preferably a single continuous ribbon, but it is equally possible to form a single continuous ribbon by combining multiple short ribbons. The sound-absorbing material which forms the continuous ribbon 41 is preferably any one material selected from the group consisting of sponge, a foamed rubber composition, glass wool, rock wool, and cellulose fiber. The continuous ribbon 41 in this mode of embodiment is made of sponge.

The sponge may be molded to a predetermined shape in advance outside the tire and then introduced into the tire cavity in order to form the continuous ribbon 41, or the continuous ribbon 41 may be formed while directly introducing (injecting), for example, the polyurethane-based material which forms the sponge into the tire cavity. Furthermore, if the polyurethane-based material which forms the continuous ribbon 41 is directly introduced into the tire cavity, there may be a difference in the growth rate of the material at the material surface and inside the material due to differences in the material temperature and ambient temperature during the process of forming the continuous ribbon 41, and a thin film-like portion may be formed at the material surface. The film-like portion which is present at the surface of this continuous ribbon 41 makes it possible to achieve an effect of preventing water from penetrating into the continuous ribbon 41 and improving the durability of the continuous ribbon 41.

The continuous ribbon 41 is fixed to the tire internal surface 2 in such a way as to occupy a range of at least 30% of the range of the tire internal surface 2 corresponding to the range where the tread 3 is formed on the inside in the radial direction of the tread 3. In this mode of embodiment, the continuous ribbon 41 is fixed to the tire internal surface 2 in such a way as to occupy a range of 85% on the inside in the radial direction of the tread 3, in other words the continuous ribbon 41 is fixed to the tire internal surface 2 in such a way as to cover 85% of the range of the tire internal surface 2 corresponding to the tread 3.

The width D of the continuous groove 5 is formed in such a way as to be at least equal to 10% of the width W of the continuous ribbon 41. In this mode of embodiment, the width D of the continuous groove 5 is 13 mm.

The continuous ribbon 41 shown in the cross-sectional view in the radial direction in FIG. 1 is formed only by a single continuous ribbon 41, as described above; as shown in FIG. 2, this continuous ribbon 41 comprises two ends, namely a start end 411 and a terminal end 412, and these two ends are formed in such a way as to be offset from each other in the axial direction, in other words in such a way as to have a space therebetween. The amount of offset of the two ends 411, 412 in this mode of embodiment is 148 mm.

In this way, in this mode of embodiment, the continuous ribbon 41 attached to the tire internal surface 2 comprises two ends, namely the start end 411 and the terminal end 412, as shown in FIG. 2, and these two ends 411, 412 are formed in such a way as to be offset from each other in the axial direction. The continuous ribbon 41 is provided on the tire internal surface 2 in such a way that a single continuous ribbon 41 runs four times around the tire, as described above, in other words it runs four times at a predetermined angle with respect to the circumferential direction of the tire, and as a result the continuous grooves 5 are formed running three times around the tire by adjacent continuous ribbons 41 and the tire internal surface 2.

It should be noted that in this mode of embodiment, the start end 411 and terminal end 412 are provided at positions which are offset on the axis of the tire internal surface 2 as a result of the continuous ribbon running four times around the circumferential direction of the tire, as shown in FIG. 2, but if the continuous ribbon 41 runs three times around the circumferential direction of the tire, for example, the continuous ribbon 41 may be provided in such a way that the start end 411 and terminal end 412 are provided at positions which are offset with respect to the circumferential direction of the tire and the start end 411 and terminal end 412 are offset in the axial direction at different positions on the axis of the tire internal surface 2.

It should be noted that in the example of the tire according to this mode of embodiment, the cross-sectional shape of the continuous ribbon 41 is a trapezoidal shape in which the upper base forms the bottom surface, but this cross-sectional shape is not limited to a trapezoidal shape in which the upper base forms the bottom surface. The cross-sectional shape of the continuous ribbon 41 should be a cross-sectional shape in which the width Wc of the bottom surface which forms the continuous groove 5 and is affixed to the tire internal surface can be made smaller than the width W of the continuous ribbon 41, and said shape may be appropriately modified to a cross-sectional shape in which the external shape outside the bottom surface which is affixed to the tire internal surface is arched or a shape in which the side surfaces or upper surface are expanded in the form of a curve, among others. It should be noted that when such shapes are adopted, the width W of the continuous ribbon 41 is the maximum width projected onto the tire internal surface 2, the thickness E is the maximum thickness in the radial direction of the tire, the width Wc of the bottom surface of the continuous ribbon which is affixed to the tire internal surface is the width of a portion parallel to the tire internal surface 2 of the attached continuous ribbon affixed to the tire internal surface 2 projected onto the tire internal surface 2, and the width D of the continuous groove formed by the continuous ribbon is the maximum gap between adjacent continuous ribbons projected onto the tire internal surface 2.

Furthermore, the continuous ribbon may be formed in such a way as to meander at a predetermined angle with respect to the circumferential direction of the tire in such a way as to form the continuous grooves. In this case, the width D of the continuous grooves may vary continuously in the direction of extension of the continuous ribbon, or the meandering shape of adjacent continuous ribbons may be arranged in such a way that the width D of the continuous grooves is constant.

The main action and effects of the pneumatic tire provided with a noise damper according to this mode of embodiment will be described next.

The continuous ribbon 41 is first of all formed in such a way as to be angled with respect to the circumferential direction of the tire in order to prevent propagation of sound waves from cavity resonance which progress in the circumferential direction of the tire, and therefore cavity resonance can be effectively reduced.

Here, cavity resonance is generated because air enclosed in the annular cavity acts as an air column as the tire travels, and this cavity resonance is a cause of air vibration whereby the inside of the air column mainly spreads in the circumferential direction of the tire. The continuous ribbon 41 is therefore disposed in such a way as to extend obliquely at a predetermined angle with respect to the circumferential direction of the tire, whereby it is possible to effectively reduce cavity resonance.

Furthermore, as described above, the continuous grooves are formed in such a way as to extend at a predetermined angle with respect to the circumferential direction of the tire, and therefore the energy of air vibration which propagates mainly in the circumferential direction of the tire from cavity resonance conducted into the continuous grooves 5 is divided into a component which permeates into the continuous ribbon 41, and a component which is reflected by the surface of the continuous ribbon 41. The energy component which permeates into the continuous ribbon 41 is attenuated by the effect of the sound-absorbing material which forms the continuous ribbon 41, and the component which is reflected by the surface of the continuous ribbon 41 is not only attenuated by reflection thereof, the energy thereof also reaches other sections of the continuous ribbon 41 whereby the abovementioned permeation/reflection phenomena are repeated, so cavity resonance can be more effectively reduced.

In addition, according to this mode of embodiment, the groove width D of the continuous groove 5 is at least equal to 10% of the width W of the continuous ribbon, so the area over which the tire internal surface comes into direct contact with air in the tire cavity by way of the continuous groove can be made a sufficient area to radiate heat. In addition, the width Wc of the bottom surface of the continuous ribbon 41 which is affixed to the tire internal surface is smaller than the width W of the continuous ribbon 41, so it is possible to further increase the surface area over which the tire internal surface comes into direct contact with air in the tire cavity by way of the continuous grooves, in order to radiate heat. This means that the heat mainly generated in the tread while the tire is travelling can be reliably released from the tire internal surface to the tire cavity even though the continuous ribbon 41 constituting the noise damper 4 is provided running multiple times (four times in this mode of embodiment) around the inside of the tread 3 in the radial direction thereof, and as a result it is possible to maintain high-speed durability.

In addition, the structure in this mode of embodiment is such that a single continuous ribbon 41 is fixed in the tire cavity running four times around the tire in such a way as to extend obliquely with respect to the circumferential direction of the tire, and therefore a fixing method may be adopted in which, for example, the start end 411 of the continuous ribbon 41 is fixed to the tire internal surface, after which the continuous ribbon 41 should continue to be fixed up to the terminal end 412 thereof while the tire 1 is rotated about the axis of rotation thereof and the continuous ribbon 41 or the tire 1 itself is moved in the axial direction. In this way, the tire 1 provided with the noise damper 4 according to this mode of embodiment enables the continuous ribbon 41 to be attached with relative ease, and the productivity of the tire 1 provided with the continuous ribbon 41 constituting the noise damper 4 can be maintained.

In addition, according to this mode of embodiment, the width W of the continuous ribbon 41 is formed in such a way as to be between 5% and 25% of the width TW of the tread 3. Here, if the width W of the continuous ribbon is less than 5% of the width TW of the tread 3, the width W of the continuous ribbon 41 is excessively small, and it is necessary to increase the number of turns of the continuous ribbon in order to effectively reduce cavity resonance, and productivity is reduced. On the other hand, if the width W of the continuous ribbon 41 is more than 25% of the tread width TW, the proportion of the tire internal surface 2 occupied by the continuous ribbon increases, and as a result the proportion of the tire internal surface 2 which comes into contact with air in the tire cavity is reduced, so the high-speed durability is reduced. Accordingly, if the width W of the continuous ribbon 41 is set between 5% and 25% of the tread width TW, it is possible to ensure high-speed durability and to maintain productivity while a reduction in cavity resonance can be envisaged.

In addition, according to this mode of embodiment, the thickness E of the continuous ribbon 41 is formed in such a way as to be between 50% and 200% of the width W of the continuous ribbon 41. Here, if the thickness E of the continuous ribbon 41 is less than 50% of the width W of the continuous ribbon 41, the thickness E of the continuous ribbon 41 does not have a sufficient height to impede propagation of sound waves from air vibration in the tire cavity, so the degree of reduction in cavity resonance is reduced. On the other hand, if the thickness E of the continuous ribbon 41 is greater than 200% of the width W of the continuous ribbon 41, the sound-suppression effect afforded by the continuous ribbon 41 plateaus, and therefore this adversely affects the cost and weight of the tire. Accordingly, if the thickness E of the continuous ribbon 41 is set between 50% and 200% of the width W of the continuous ribbon 41 it is possible to reduce cavity resonance more effectively, and it is possible to suppress increases in the cost and weight.

A pneumatic tire according to a second mode of embodiment of the present invention will be described next with the aid of FIG. 3.

FIG. 3 is a schematic view of the internal surface of a pneumatic tire provided with a noise damper according to a second mode of embodiment of the present invention. It should be noted that the basic structure and effects of the second mode of embodiment are the same as those of the first mode of embodiment described above, and therefore the description given here will mainly relate to the structure and effects which differ from those of the first mode of embodiment and the structure and effects which are the same as in the first mode of embodiment will not be described again.

As shown in FIG. 3, according to the second mode of embodiment, two continuous ribbons 41, 42 are attached in such a way as to each run three times around the internal surface 2 of the pneumatic tire 1. The two continuous ribbons 41, 42 are both inclined in the same direction with respect to the circumferential direction of the tire, and continuous grooves 5 which are the same as those of the first mode of embodiment are formed by each. The continuous grooves 5 which are formed by the two continuous ribbons 41, 42 and the tire internal surface 2 are formed in such a way as to have the same width D.

The second mode of embodiment makes it possible to increase the degree of freedom in the position where the continuous ribbon 41 is attached to the tire internal surface 2, and the most effective place for attenuating cavity resonance can be selected as the place of attachment.

It should be noted that the inclinations of the two continuous ribbons 41 with respect to the circumferential direction of the tire may also be different, and the width D of the continuous grooves 5 may also differ for each continuous ribbon 41.

A pneumatic tire according to a third mode of embodiment of the present invention will be described next with the aid of FIG. 4.

FIG. 4 is a schematic view of the internal surface of a pneumatic tire provided with a noise damper according to a third mode of embodiment of the present invention. It should be noted that the basic structure and effects of the third mode of embodiment are the same as those of the first mode of embodiment described above, and therefore the description given here will mainly relate to the structure and effects which differ from those of the first mode of embodiment and the structure and effects which are the same as in the first mode of embodiment will not be described again.

As shown in FIG. 4, according to the third mode of embodiment, two continuous ribbons 41, 42 are attached in such a way as to each run three times around the internal surface 2 of the pneumatic tire 1. According to the third mode of embodiment, the first continuous ribbon 41 is attached in such a way as to extend in an oblique direction with respect to the circumferential direction of the tire about the axis of rotation thereof in the same way as in the first mode of embodiment, and the second continuous ribbon 42 is attached in such a way as to extend in a direction about the axis of rotation which is symmetrical, with respect to the circumferential direction of the tire, to the direction in which the first continuous ribbon 41 extends. Both of the continuous ribbons 41, 42 also form continuous grooves 5 together with the tire internal surface 2, in the same way as in the first mode of embodiment, and the continuous grooves 5 which are formed by the continuous ribbons 41, 42 and the tire internal surface 2 have the same width D.

The third mode of embodiment makes it possible to increase the degree of freedom in the position where the continuous ribbon 41 is attached to the tire internal surface 2, and the most effective place for attenuating cavity resonance can be selected as the place of attachment.

It should be noted that the inclinations of the two continuous ribbons 41 may also be different, and the width D of the continuous grooves 5 may also differ for each continuous ribbon 41.

A pneumatic tire according to a fourth mode of embodiment of the present invention will be described next with the aid of FIG. 5.

FIG. 5 is a schematic view of the internal surface of a pneumatic tire provided with a noise damper according to a fourth mode of embodiment of the present invention. It should be noted that the basic structure and effects of the fourth mode of embodiment are the same as those of the first mode of embodiment described above, and therefore the description given here will mainly relate to the structure and effects which differ from those of the first mode of embodiment and the structure and effects which are the same as in the first mode of embodiment will not be described again.

As shown in FIG. 5, according to the fourth mode of embodiment, one continuous ribbon 41 is attached in such a way as to run five times around the internal surface 2 of the pneumatic tire 1, and the groove width D of the continuous grooves 5 formed by the continuous ribbon 41 and the tire internal surface 2 of the tire is formed in such a way as to vary over each circuit. According to the fourth mode of embodiment, the groove width D of the continuous grooves 5 varies between 15 mm and 54 mm. It should be noted that the groove width D of the continuous grooves 5 may vary continuously in the direction in which the continuous ribbon 41 extends.

According to the fourth mode of embodiment, the width D of the continuous grooves 5 is variable, and as a result it is possible to reduce cavity resonance more effectively. That is to say, the energy of air vibration from cavity resonance conducted into the continuous grooves 5 permeates into the continuous ribbon 41 in an irregular manner within the continuous grooves 5, or is repeatedly reflected by the surface of the continuous ribbon 41, and as a result cavity resonance can be more effectively improved.

It should be noted that in this mode of embodiment, the groove width D of the continuous grooves 5 is made to vary for each circuit in the direction of attachment of the continuous ribbon 41, but the groove width D of the continuous grooves 5 may be made to vary by attaching the continuous ribbon 41 to the tire internal surface 2 in such a way as to form a zigzag or a meander, for example, or the width W of the continuous ribbon 41 may be variable, or the variation may be achieved by means of another method (not depicted).

A pneumatic tire according to a fifth mode of embodiment of the present invention will be described next with the aid of FIG. 6.

FIG. 6 is a schematic view in cross section in the radial direction of a pneumatic tire provided with a noise damper according to a fifth mode of embodiment of the present invention. It should be noted that the basic structure and effects of the fifth mode of embodiment are the same as those of the first mode of embodiment described above, and therefore the description given here will mainly relate to the structure and effects which differ from those of the first mode of embodiment and the structure and effects which are the same as in the first mode of embodiment will not be described again.

As shown in FIG. 6, a single continuous ribbon 41 having a thickness E which is between 50% and 200% of the width W, in which the cross-sectional shape is trapezoidal with the upper base forming the bottom surface, is attached in such a way that the start end and terminal end are offset in the axial direction, and runs four times around the tire internal surface 2 about the axis of rotation of the tire, and the same continuous grooves 5 are formed as in the first mode of embodiment. In the fifth mode of embodiment, the width W of the continuous ribbon 41 is 24 mm, the thickness E is 25 mm, which is 104% of the width W, the width Wc of the bottom surface is 18 mm, and the groove width D of the continuous grooves 5 is 15 mm.

In the fifth mode of embodiment, the thickness E of the continuous ribbon 41 is relatively thicker than it is in the first mode of embodiment, lying in the range of between 50% and 200% of the width W, and therefore it is possible to increase the surface area of the continuous ribbon 41 which is in contact with the tire cavity in a range such that there is no adverse effect in terms of increasing the cost and weight, while a sufficient height can be maintained for the thickness E of the continuous ribbon 41 in order to avoid propagation of sound waves from air vibration in the tire cavity. This means that air vibration which permeates into the continuous ribbon 41 or is reflected by the surface of the continuous ribbon 41 is increased and it is possible to more effectively avoid propagation of sound waves, and as a result cavity resonance can be more effectively improved.

A pneumatic tire according to a sixth mode of embodiment of the present invention will be described next with the aid of FIG. 7.

FIG. 7 is a schematic view in cross section in the radial direction of a pneumatic tire provided with a noise damper according to a sixth mode of embodiment of the present invention. It should be noted that the basic structure and effects of the sixth mode of embodiment are the same as those of the first mode of embodiment described above, and therefore the description given here will mainly relate to the structure and effects which differ from those of the first mode of embodiment and the structure and effects which are the same as in the first mode of embodiment will not be described again.

As shown in FIG. 7, according to the sixth mode of embodiment, a single continuous ribbon 41 which is formed in such a way that the cross-sectional shape thereof is arched (for example the “semicircular” cross-sectional shape shown in the figure) and the ratio of the width W thereof with respect to the width Wc of the bottom surface which is affixed to the tire internal surface (W/Wc) is at least equal to 1.2, is attached in such a way that the start end and terminal end are offset in the axial direction, and runs four times around the tire internal surface 2 about the axis of rotation of the tire, and the same continuous grooves 5 as in the first mode of embodiment are formed. According to the sixth mode of embodiment, the width W of the continuous ribbon 41 is 24 mm, the thickness E is 15 mm, the width Wc of the bottom surface is 18 mm, and the groove width D of the continuous grooves 5 is 15 mm.

According to the sixth mode of embodiment, the cross-sectional shape of the continuous ribbon 41 is arched as described above, and therefore the area over which the tire internal surface comes into direct contact with the air in the tire cavity by way of the continuous groove increases so heat radiation is ensured, while at the same time the center of gravity of the continuous ribbon 41 can be brought closer to the tire internal surface 2 than a trapezoidal continuous ribbon in which the upper base forms the bottom surface as described above. It is therefore possible to reduce the stress exerted on the bottom surface which is affixed to the tire internal surface when the continuous ribbon 41 is subjected to force due to deformation of the tire, and as a result it is possible to more effectively improve the high-speed durability.

Especially preferred modes of embodiment of the present invention have been described above, but the present invention is not limited to the modes of embodiment shown in the figures, and a number of variations may be implemented.

FIG. 8 is a schematic view in cross section in the radial direction of a pneumatic tire provided with a noise damper according to the prior art. The size of the tire shown in FIG. 8 is the same as that of the pneumatic tire 1 according to the first mode of embodiment. A ribbon 141 formed by a noise damper 104 for reducing cavity resonance is attached to the internal surface 102 of a pneumatic tire 100 according to the prior art. The ribbon 141 continues four times around the circumferential direction of the tire in such a way as to form continuous grooves 105, and the two ends thereof are attached in such a way as to be offset. The cross-sectional shape of the continuous ribbon 141 is a trapezoidal shape in which the lower base forms the bottom surface which is affixed to the tire internal surface 102, and the width of the bottom surface is the same as the maximum width W of the continuous ribbon 141. It should be noted that in FIG. 8 the width of the ribbon at 141 is 24 mm and the thickness is 15 mm.

### Exemplary Embodiment

In order to clarify the advantage of the present invention, pneumatic tires according to a conventional example which was not provided with a noise damper, a comparative example in which a noise damper was provided, and Exemplary Embodiment 1 in accordance with the present invention (first mode of embodiment) will be described with regard to results which were investigated using a simulation (finite element method) employing commercially-available computer software.

The tire size used for the tire models according to the conventional example, comparative example and Exemplary Embodiment 1 was 225/55R16, the wheel size was 7.0 J×16, the internal pressure was set at 230 kPa, and the load was set at 542 daN, in all cases. It should be noted that the comparative example employed a tire model corresponding to that shown in FIG. 8, and was set in such a way that the cross-sectional area of the ribbon 43 was the same as that of the continuous ribbon 41 in the model according to Exemplary Embodiment 1, and the material used was the same as that used for the continuous ribbon 41.

The noise levels of the abovementioned tire models were simulated by using a point sound source in the tire cavity, with the abovementioned rim, internal pressure and load. The calculated noise was displayed as an index of the acoustic pressure level with respect to a conventional example, using the acoustic pressure level imparted from filter A in a frequency band between 190 and 230 Hz which includes a primary peak of cavity resonance. The higher the numerical value the better the result.

Furthermore, the maximum temperature in the range of the inside in the radial direction corresponding to the tread in the vicinity of the tire internal surface when said tires were rotated at 80 km/h using the abovementioned rim, internal pressure and load was simulated for the abovementioned tire models. The maximum temperature calculated was displayed as an index with respect to a conventional example. The higher the numerical value the better the result.

TABLE 1

| | Exemplary | Conventional | Comparative |
|---|---|---|---|
| | Embodiment 1 | Example | Example |
| Noise | 110 | 100 | 110 |
| performance | | | |
| (index) | | | |
| Heat radiation | 99 | 100 | 97 |
| performance | | | |
| (index) | | | |

As shown in Table 1, it was possible to confirm that cavity resonance could be effectively reduced in the pneumatic tire according to Exemplary Embodiment 1, and the configuration of the pneumatic tires in the first to sixth modes of embodiment described above also made it possible to maintain high-speed durability, and productivity could also be ensured.

### Key to Symbols

1 Pneumatic tire
2 Tire internal surface
3 Tread
4 Noise damper
41 Continuous ribbon formed by suppressor
411 Start end of continuous ribbon
412 Terminal end of continuous ribbon
413 Bottom surface of continuous ribbon affixed to tire internal surface
5 Continuous groove

1. A pneumatic tire comprising a tread, a cavity enclosed by a tire internal surface, and a noise damper for reducing cavity resonance in said cavity,
the noise damper comprising at least one continuous ribbon which is formed by a predetermined sound-absorbing material and has a width W and thickness E, and a bottom surface affixed to the tire internal surface over a width Wc, which is fixed to the tire internal surface in such a way as to cover a range of at least 30% of the inside of the tire in the radial direction corresponding to the tread on the tire internal surface;
wherein the at least one continuous ribbon is disposed in such a way as to run at least once around the tire internal surface about the axis of rotation thereof, and in such a way that the start end and terminal end of the at least one continuous ribbon are offset from each other in the direction of the axis of rotation of the tire, and as a result a continuous groove having a groove width D which is at least equal to 10% of the width W of the at least one continuous ribbon is formed by the adjacent portions of the at least one continuous ribbon and the tire internal surface; and
wherein the width Wc of the bottom surface of the continuous ribbon is smaller than the width W of the continuous ribbon.

2. The pneumatic tire according to claim 1, wherein the ratio of the width W of the at least one continuous ribbon to the width Wc of the bottom surface (W/Wc) is at least equal to 1.2.

3. The pneumatic tire according to claim 2, wherein the tread has a width TW, and the width W of the at least one continuous ribbon is between 5% and 25% of the width TW of the tread.

4. The pneumatic tire according to claim 3, wherein the at least one continuous ribbon is disposed in such a way as to run at least twice around the tire internal surface.

5. The pneumatic tire according to claim 4, wherein the predetermined sound-absorbing material of the at least one continuous ribbon is selected from the group consisting of sponge, a foamed rubber composition, glass wool, rock wool, and cellulose fiber.

6. The pneumatic tire according to claim 5, wherein the thickness E of the at least one continuous ribbon is between 50% and 200% of the width W of the at least one continuous ribbon.

7. The pneumatic tire according to claim 6, wherein the groove width D of the continuous groove is formed in such a way as to vary in a range between 10% and 250% of the width W of the at least one continuous ribbon in the direction in which the at least one continuous ribbon runs.

8. The pneumatic tire according to claim 6, wherein there are two of the abovementioned at least one continuous ribbon, and the continuous groove is formed for each of the two continuous ribbons by the continuous ribbons and the tire internal surface.

9. The pneumatic tire according to claim 6, wherein there are two of the abovementioned at least one continuous ribbon, namely a first continuous ribbon extending in a predetermined angular direction with respect to the circumferential direction of the tire about the axis of rotation of the tire, and a second continuous ribbon extending in a direction which is symmetrical, with respect to the circumferential direction of the tire, to the predetermined angular direction along which the first continuous ribbon runs.
